(19) United States
(12) Patent Application Publication
(10) Pub. No.: US 2023/0171739 A1
(43) Pub. Date: Jun. 1, 2023

(54) MONITORING METHOD AND APPARATUS IN SIDELINK COMMUNICATION, AND STORAGE MEDIUM

(71) Applicant: Beijing Xiaomi Mobile Software Co., Ltd., Beijing (CN)

(72) Inventor: Qun ZHAO, Beijing (CN)

(21) Appl. No.: 17/997,723

(22) PCT Filed: May 7, 2020
(86) PCT No.: PCT/CN2020/089073

§ 371 Date: Nov. 1, 2022

(51) Int. Cl. H04W 72/02; H04W 72/0446; H04W 72/25

(52) U.S. Cl. CPC H04W 72/02; H04W 72/25; H04W 72/0446

(57) ABSTRACT

A signal monitoring method in sidelink communication includes: for a sidelink communication resource pool of a sidelink communication device, determining a first time unit in the sidelink communication resource pool; and performing a signal monitoring operation in the first time unit; and the first time unit is periodic, where in one period, the first time unit is one time unit or a plurality of continuous time units.

### TECHNICAL FIELD

Examples of the disclosure relate to the technical field of communication, and in particular to a monitoring method and apparatus in sidelink communication, and a storage medium.

### BACKGROUND

A vehicle to everything (V2X) technology, also known as a wireless communication technology for vehicles, is a new-generation information communication technology that connects vehicles with everything.

In general, according to the V2X technology in a 5G new radio (NR) system, higher communication rate, shorter communication delay and more reliable communication quality can be provided. However, at present, the V2X technology in the 5G NR system takes a main consideration on optimizing communication between sidelink communication devices, with a little consideration on energy-saving optimization of the sidelink communication devices.

### SUMMARY

Examples of the disclosure provide a monitoring method and apparatus in sidelink communication, and a storage medium, which may shorten the time for a sidelink communication device to perform a signal monitoring operation, and save the electric quantity of the device. The technical solutions are as follows:
according to one aspect, the examples of the disclosure provide a monitoring method in sidelink communication, applied to a sidelink communication device. The method includes:
for a sidelink communication resource pool of a sidelink communication device, determining a first time unit in the sidelink communication resource pool; and
performing a signal monitoring operation in the first time unit.

Optionally, the first time unit is periodic.

Optionally, in one period, the first time unit is one time unit or a plurality of continuous time units.

Optionally, determining the first time unit in the sidelink communication resource pool based on the configuration information includes:

determining the first time unit in the sidelink communication resource pool based on configuration information.

Optionally, the configuration information includes at least one of:
a period of the first time unit;
a time domain start position of the first time unit in one period;
a time domain end position of the first time unit in one period;
a time domain length of the first time unit in one period; and
a time domain bitmap of the first time unit in one period.

Optionally, the configuration information includes a plurality of candidate configuration values, where each of the configuration values corresponds to one group of configuration parameters.

Determining the first time unit in the sidelink communication resource pool based on the configuration information includes:
selecting a first configuration value from the plurality of candidate configuration values; and
determining the first time unit in the sidelink communication resource pool based on the configuration parameters corresponding to the first configuration value.

Optionally, selecting the first configuration value from the plurality of candidate configuration values includes:

selecting the first configuration value from the plurality of candidate configuration values according to a resource reservation period of to-be-sent or to-be-received sidelink communication information.

Optionally, the period of the first time unit is the same as or in an integral multiple relationship with the resource reservation period.

Optionally, selecting the first configuration value from the plurality of candidate configuration values includes:

selecting the first configuration value from the plurality of candidate configuration values according to a priority of to-be-sent or to-be-received sidelink communication information.

Optionally, the configuration information further includes a mapping relationship between the configuration values and the priority.

Optionally, the configuration information is preconfigured, or the configuration information is configured by a base station through a downlink signaling.

Optionally, the method further includes:

sending time domain position indicating information to other sidelink communication devices, where the time domain position indicating information is used to indicate a time domain position of the first time unit.

Optionally, sending the time domain position indicating information to other sidelink communication devices includes:
sending sidelink control information (SCI) to other sidelink communication devices, where the SCI includes the time domain position indicating information; or,
sending a sidelink radio resource control (RRC) message to the other sidelink communication devices, where the sidelink RRC message includes the time domain position indicating information.

Optionally, the time domain position indicating information is used by the other sidelink communication devices to determine a time unit at which a signal monitoring operation is performed and/or a time unit at which an energy-saving state enters in the own sidelink communication resource pool.

Optionally, the method further includes:

selecting a transmission resource for sidelink communication based on the monitoring result of the signal monitoring operation.

Optionally, selecting the transmission resource for sidelink communication based on the monitoring result of the signal monitoring operation includes:
selecting the transmission resource for sidelink communication from a resource selecting window based on the monitoring result of the signal monitoring operation,
where the resource selecting window is in the first time unit.

Optionally, a signal monitoring window in which the signal monitoring operation is performed is before the resource selecting window, and time unit of an interval between the signal monitoring window and the resource selecting window is not less than M, where M is a positive integer.

Optionally, the M is a fixed value, or the M is preconfigured or configured by a base station through a downlink signaling.

Optionally, the number of time units included in the resource selecting window is not less than L, and the L is a positive integer.

Optionally, the L is a fixed value, or the L is preconfigured or configured by a base station through a downlink signaling.

Optionally, the method further includes:

performing the signal monitoring operation from a time unit before the first time unit in the case that time when resource selection is triggered is outside the first time unit.

Optionally, the signal monitoring operation includes a monitoring operation for a signal and/or a channel for sidelink communication.

According to another aspect, the examples of the disclosure provide a monitoring apparatus in sidelink communication. The apparatus includes:
a time determining module, configured to: for a sidelink communication resource pool of a sidelink communication device, determine a first time unit in the sidelink communication resource pool; and
a signal monitoring module, configured to perform a signal monitoring operation in the first time unit.

Optionally, the first time unit is periodic.

Optionally, in one period, the first time unit is one time unit or a plurality of continuous time units.

Optionally, the time determining module is configured to determine the first time unit in the sidelink communication resource pool based on configuration information.

Optionally, the configuration information includes at least one of:
a period of the first time unit;
a time domain start position of the first time unit in one period;
a time domain end position of the first time unit in one period;
a time domain length of the first time unit in one period; and
a time domain bitmap of the first time unit in one period.

Optionally, the configuration information includes a plurality of candidate configuration values, where each of the configuration values corresponds to one group of configuration parameters.

The time determining module includes:
a configuration selecting unit, configured to select a first configuration value from the plurality of candidate configuration values; and
a time determining unit, configured to determine the first time unit in the sidelink communication resource pool based on the configuration parameters corresponding to the first configuration value.

Optionally, the configuration selecting unit is configured to select the first configuration value from the plurality of candidate configuration values according to a resource reservation period of to-be-sent or to-be-received sidelink communication information.

Optionally, the period of the first time unit is the same as or in an integral multiple relationship with the resource reservation period.

Optionally, the configuration selecting unit is configured to select the first configuration value from the plurality of candidate configuration values according to a priority of to-be-sent or to-be-received sidelink communication information.

Optionally, the configuration information further includes a mapping relationship between the configuration values and the priority.

Optionally, the configuration information is preconfigured, or the configuration information is configured by a base station through a downlink signaling.

Optionally, the apparatus further includes:

an information sending module, configured to send time domain position indicating information to other sidelink communication devices, where the time domain position indicating information is used to indicate a time domain position of the first time unit.

Optionally, the information sending module is configured to: send SCI to the other sidelink communication devices, where the SCI includes the time domain position indicating information; or send a sidelink RRC message to the other sidelink communication devices, where the sidelink RRC message includes the time domain position indicating information.

Optionally, the time domain position indicating information is used by the other sidelink communication devices to determine a time unit at which a signal monitoring operation is performed and/or a time unit at which an energy-saving state enters in the own sidelink communication resource pool.

Optionally, the apparatus further includes:

a resource selecting module, configured to select a transmission resource for sidelink communication based on the monitoring result of the signal monitoring operation.

Optionally, the resource selecting module is configured to select the transmission resource for sidelink communication from a resource selecting window based on the monitoring result of the signal monitoring operation, where the resource selecting window is in the first time unit.

Optionally, a signal monitoring window in which the signal monitoring operation is performed is before the resource selecting window, and time unit of an interval between the signal monitoring window and the resource selecting window is not less than M, where M is a positive integer.

Optionally, the M is a fixed value, or the M is preconfigured or configured by a base station through a downlink signaling.

Optionally, the number of time units included in the resource selecting window is not less than L, and the L is a positive integer.

Optionally, the L is a fixed value, or the L is preconfigured or configured by a base station through a downlink signaling.

Optionally, the signal monitoring module is configured to perform the signal monitoring operation from a time unit before the first time unit in the case that time when resource selection is triggered is outside the first time unit.

Optionally, the signal monitoring operation includes a monitoring operation for a signal and/or a channel for sidelink communication.

According to yet another aspect, the examples of the disclosure provide a monitoring apparatus in sidelink communication. The apparatus includes:
a processor; and
a memory configured to store an executable instruction of the processor,
where the processor is configured to execute the executable instruction to implement the above monitoring method in sidelink communication.

According to still another aspect, the examples of the disclosure provide a non-transitory computer-readable storage medium, where the non-transitory computer-readable storage medium stores a computer program, and when the computer program is executed by a processor, the above monitoring method in sidelink communication is implemented.

The technical solutions provided by the examples of the disclosure may include the following beneficial effects:

for the sidelink communication resource pool of the sidelink communication device, the first time unit in the sidelink communication resource pool is determined, the signal monitoring operation is performed in the first time unit, so that the sidelink communication device may perform the signal monitoring operation in one part of the time unit in the sidelink communication resource pool, and may enter the energy-saving state in the other part of the time unit without performing the signal monitoring operation, so that the time for performing the signal monitoring operation is shortened, and the electric quantity of the device is saved.

It should be understood that the above general description and the following detailed description are exemplary and explanatory, and cannot limit the disclosure.

### BRIEF DESCRIPTION OF THE DRAWINGS

The accompanying drawings here are incorporated into the specification and constitute a part of the specification, show examples consistent with the disclosure, and are used to explain the principle of the disclosure together with the specification.

FIG. 1 is a schematic diagram of a network architecture according to an example;

FIG. 2 is a flowchart of a monitoring method in sidelink communication according to an example;

FIG. 3 is a schematic diagram of a signal monitoring period according to an example;

FIG. 4 is a flowchart of a monitoring method in sidelink communication according to another example;

FIG. 5 is a schematic diagram of several kinds of signal monitoring and resource selection according to an example;

FIG. 6 is a block diagram of a monitor apparatus in sidelink communication according to an example;

FIG. 7 is a block diagram of a monitoring apparatus in sidelink communication according to another example; and

FIG. 8 is a structural block diagram of a sidelink communication device according to an example.

### DETAILED DESCRIPTION

Examples will be described in detail here, and the instances of the examples are shown in the accompanying drawings. When the following description involves the accompanying drawings, the same reference numerals in different drawings represent the same or similar elements, unless otherwise represented. The implementation manners set forth in the following description of examples do not represent all implementation manners consistent with the disclosure. Instead, these implementation manners are examples of apparatuses and methods consistent with aspects related to the disclosure as recited in the appended claims.

The network architecture and service scenario described in the examples of the disclosure are intended to more clearly illustrate the technical solutions of the examples of the disclosure, and do not constitute limitations on the technical solutions provided in the examples of the disclosure. Those of ordinary skill in the art can know that, with the evolution of the network architecture and the emergence of new service scenarios, the technical solutions provided in the examples of the disclosure are also applicable to similar technical problems.

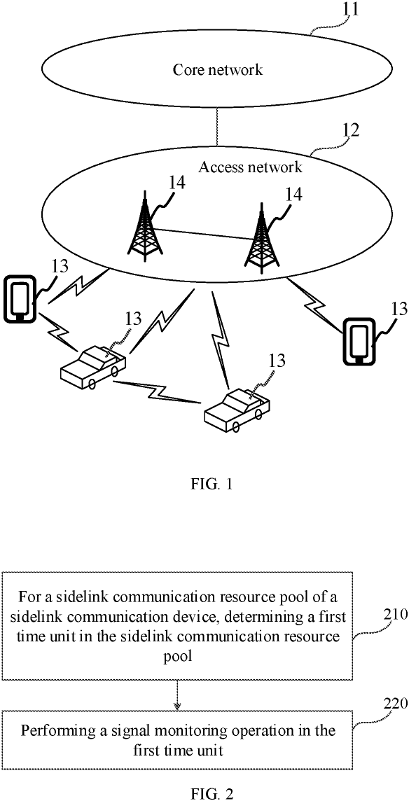

FIG. 1 is a schematic diagram of a network architecture according to an example. The network architecture may include: a core network 11, an access network 12 and a terminal 13.

The core network 11 includes a plurality of core network devices. The function of a core network device is mainly to provide user connection, user management and service bearing, and serves as a bearing network to provide an interface to an external network. For example, the core network in the 5G NR system may include an access and mobility management function (AMF) entity, a user plane function (UPF) entity, a session management function (SMF) entity and other devices.

The access network 12 includes a plurality of base stations 14. The access network in the 5G NR system may be referred to as a new generation-radio access network (NG-RAN). The base station 14 is an apparatus deployed in the access network 12 to provide a wireless communication function for the terminal 13. The base station 14 may include various forms of macro base stations, micro base stations, relay stations, access points, and the like. In systems using different radio access technologies, names of devices having functions of a base station may vary. For example, in the 5G NR system, the device is referred to as gNodeB or gNB. The name “base station” may vary with evolution of communication technologies. For the convenience of description, in the examples of the disclosure, the above devices providing the wireless communication function for the terminal 13 are collectively referred to as base stations.

A plurality of terminals 13 are generally provided, and one or more terminals 13 may be distributed in cells managed by each of the base stations 14. The terminal 13 may include various handheld devices, vehicle-mounted devices, wearable devices, computing devices or other processing devices connected to wireless modems with wireless communication functions, and various forms of user equipment (UE), mobile stations (MS), terminal devices and the like. For the convenience of description, the devices mentioned above are collectively referred to as terminals. The base stations 14 and the core network devices communicate with each other through some air technologies, for example, an NG interface in the 5G NR system. The base stations 14 and the terminals 13 communicate with each other through some air technologies, for example, a Uu interface.

In an NR V2X (or referred to as 5G V2X) technology, the terminal 13 and the terminal 13 (for example, a vehicle-mounted device and other devices (such as other vehicle-mounted devices, a mobile phone, a road side unit (RSU) and the like)) may communicate with each other through a sidelink communication interface (such as a PC5 interface). Correspondingly, a communication link established on the basis of a sidelink communication interface may be referred to as a sidelink. Compared with Uu interface-based communication, sidelink communication interface-based communication has the characteristics of short delay, low overhead and the like, and is suitable for communication between two geographically close terminals (such as a vehicle-mounted device and other geographically close peripheral devices).

“Sidelink communication device” in the examples of the disclosure refers to a terminal with sidelink communication ability.

“5G NR system” in the examples of the disclosure may also be referred to as a 5G system or an NR system, but those skilled in the art may understand the meaning of the 5G NR system. The technical solution described in the examples of the disclosure may be suitable for the 5G NR system, and may also be suitable for the subsequent evolution system of the 5G NR system.

FIG. 2 is a flowchart of a monitoring method in sidelink communication according to an example. The method may be applied to a sidelink communication device. The method may include the following steps (210-220):
in the step 210, for a sidelink communication resource pool of a sidelink communication device, a first time unit in the sidelink communication resource pool is determined; and
in the step 220, a signal monitoring operation is performed in the first time unit.

The sidelink communication resource is a set of transmission resources (for example, including time-frequency resources) that may be used for sidelink communication. One or more sidelink communication resource pools may be distributed for one terminal. The sidelink communication resource pool may be preconfigured, or may be configured by a base station through a downlink signaling.

In the examples of the disclosure, the first time unit is part of time units in the sidelink communication resource pool, but not all time units in the sidelink communication resource pool. Depending on the specific implementation manners, the first time unit may include one or more continuous or discontinuous time units. The sidelink communication device merely performs a signal monitoring operation in part of the time units in the sidelink communication resource pool, but does not perform the signal monitoring operation in all the time units in the sidelink communication resource pool, so that the time for performing the signal monitoring operation is shortened and the electric quantity of the device is saved.

In the examples of the disclosure, the time unit refers to a measurement unit of a time domain resource. For example, the time unit may be a time domain dividing unit in a communication system, such as a slot. In some other examples, the time unit may further be a frame, a subframe, a subslot, an orthogonal frequency division multiplexing (OFDM) symbol and the like, or may further be absolute time such as 1 ms and 1 us, which will not be limited in the examples of the disclosure.

Optionally, the signal monitoring operation includes a monitoring operation for a signal and/or a channel for sidelink communication, and includes: detecting the signal and/or channel and performing corresponding measurement according to received information. For example, a physical sidelink control channel (PSCCH) is blindly detected in NR V2X, stage1 sidelink control information (stage1 SCI) included in the PSCCH is received, and then a sidelink reference signal receiving power is measured according to resource indication and reserved information in the information.

Optionally, the sidelink communication device may further determine a second time unit in the sidelink communication resource pool and enter an energy-saving state in the second time unit. The sidelink communication device does not perform the signal monitoring operation in the energy-saving state. It should be noted that the sidelink communication device does not perform the signal monitoring operation, which refers to that the monitoring operation of the signal and/or the channel related to the sidelink communication is not performed, and the monitoring operation of the signal and/or the channel related to non-sidelink communication may still be performed if necessary, which will not be limited in the examples of the disclosure.

Optionally, the second time unit includes other time units except the first time unit in the sidelink communication resource pool. That is, the sidelink communication device performs a signal monitoring operation in one part of time units (that is, the first time unit) in the sidelink communication resource pool, and enters an energy-saving state in the other part of time units (that is the second time unit) without performing the signal monitoring operation.

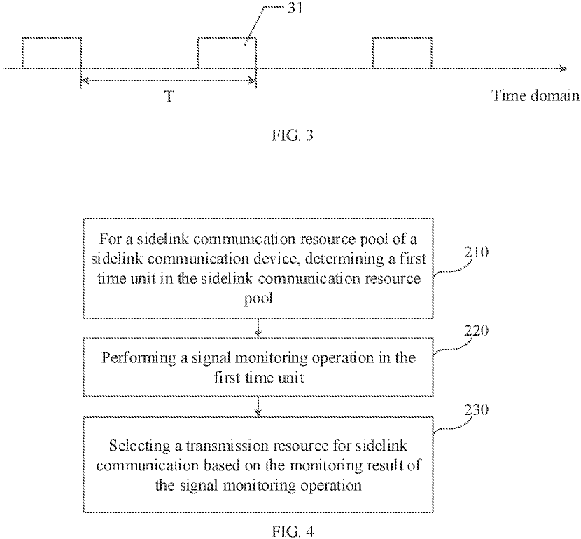

Optionally, the first time unit is periodic. To facilitate understanding, the time unit (that is, the first time unit) that needs to perform the signal monitoring operation in one period may be referred to as an active time unit, and the time unit (that is, the second time unit) that does not need to perform the signal monitoring operation in one period may be referred to as an inactive time unit. As shown in FIG. 3, the first time unit 31 is periodic, and the period is T.

Optionally, in one period, the first time unit is one time unit or a plurality of continuous time units. In one case, “continuous” here refers to: the first time unit includes a plurality of continuous logical time units. The logical time unit refers to: those time units that can be used by sidelink communication are considered. A physical time unit refers to all the time units, including time units that can be used by sidelink communication and further including time units that cannot be used by sidelink communication (for example, configured as downlink time units or occupied by other uses). Certainly, in other examples, “continuous” here may further refer to that the first time unit includes a plurality of continuous physical units, which will not be limited by the examples of the disclosure. Optionally, in one period, the first time unit may further include a plurality of discontinuous time units, which will not be limited by the examples of the disclosure.

Optionally, the sidelink communication device determines the first time unit in the sidelink communication resource pool based on configuration information. The configuration information is information for configuring the first time unit. Optionally, the configuration information includes at least one of: a period of the first time unit, a time domain start position of the first time unit in one period, a time domain end position of the first time unit in one period, a time domain length of the first time unit in one period, and a time domain bitmap of the first time unit in one period. The time domain bitmap of the first time unit in one period is used to indicate each time unit occupied by the first time unit in one period. For example, one period includes 20 slots, the first time unit occupies the first to fourth slots, then the time domain bitmap includes 20 bits, where the first to fourth bits are first values, and the fifth to twentieth bits are second values. The first value and the second value are different, for example, the first value is 0 and the second value is 1, or the first value is 1 and the second value is 0. For another example, one period includes 20 slots, the first time unit occupies the first to fourth slots, and the eleventh to twelfth slots, then the time domain bitmap includes 20 bits, where the first to fourth bits and the eleventh to twelfth bits are first values, and the fifth to tenth bits and the thirteenth to twentieth bits are second values. When the first time unit in one period includes a plurality of discontinuous time units, the time domain bitmap can be used to perform indication more simply.

Optionally, the configuration information may be preconfigured, or may be configured by a base station through a downlink signaling. In the examples of the disclosure, preconfiguration refers to preconfiguration in a communication chip of a terminal. The configuration by the base station through the downlink signaling refers to: the base station sends the downlink signaling such as an RRC signaling and a medium access control (MAC) signaling to the terminal, and carries configuration information or other parameters in the downlink signaling to realize configuration.

Optionally, the configuration information includes a plurality of candidate configuration values, and each of the configuration values corresponds to one group of configuration parameters. The sidelink communication device may select a first configuration value from a plurality of candidate configuration values, and determine the first time unit in the sidelink communication resource pool based on the configuration parameter corresponding to the first configuration value. In this way, the sidelink communication device determines to adopt one of the configuration values independently, which is more flexible.

In one example, the sidelink communication device selects a first configuration value from a plurality of candidate configuration values according to a resource reservation period of to-be-sent or to-be-received sidelink communication information. Optionally, the period of the first time unit is the same as or in an integral multiple relationship with the resource reservation period. The sidelink communication device may select the first configuration value from the plurality of candidate configuration values based on the selection condition.

In another example, the sidelink communication device selects a first configuration value from a plurality of candidate configuration values according to a priority of to-be-sent or to-be-received sidelink communication information. Optionally, the configuration information further includes a mapping relationship between the configuration values and the priority. The sidelink communication device acquires the configuration value corresponding to the priority of the to-be-sent or to-be-received sidelink communication information based on the mapping relationship to serve as the first configuration value. For example, the configuration information includes the mapping relationship between the number of the time units that need to perform the signal monitoring operation in the period and the priority; and the sidelink communication device selects the corresponding number of the time units according to the priority of the to-be-sent or to-be-received sidelink communication information, so that the time domain position of the first time unit is determined.

Optionally, the sidelink communication device may further send time domain position indicating information to other sidelink communication devices, where the time domain position indicating information is used to indicate a time domain position of the first time unit. For example, the time domain position indicating information may include at least one of: a period of the first time unit, a time domain start position of the first time unit in one period, a time domain end position of the first time unit in one period, a time domain length of the first time unit in one period, and a time domain bitmap of the first time unit in one period.

In one example, the sidelink communication device sends SCI to other sidelink communication devices, where the SCI includes the time domain position indicating information. In another example, the sidelink communication device sends a sidelink RRC message to other sidelink communication devices, where the sidelink RRC message includes time domain position indicating information. For example, the SCI or sidelink RRC message includes specific bits. Different bit values represent different period lengths, or represent the position of the first time unit in the period, or represent a possible combination of the period length and the position of the first time unit in the period.

Optionally, the time domain position indicating information is used by the other sidelink communication devices to determine a time unit at which a signal monitoring operation is performed and/or a time unit at which an energy-saving state enters in the own sidelink communication resource pool. For example, other sidelink communication devices may determine the time unit at which the signal monitoring operation is performed, which is the same as the first time unit indicated by the received time domain position indicating information, so that a plurality of sidelink communication devices perform the signal monitoring operation in the same time unit, and enter the energy-saving state in the same time unit, which has good synchronization performance in a vehicles platooning scenario.

In conclusion, according to the technical solutions provided by the examples of the disclosure, for the sidelink communication resource pool of the sidelink communication device, the first time unit in the sidelink communication resource pool is determined, the signal monitoring operation is performed in the first time unit, so that the sidelink communication device may perform the signal monitoring operation in one part of the time unit in the sidelink communication resource pool, and may enter the energy-saving state in the other part of the time unit without performing the signal monitoring operation, so that the time for performing the signal monitoring operation is shortened and the electric quantity of the device is saved.

In the example, as shown in FIG. 4, after the step 220, the method may further include the following steps:

in the step 230, a transmission resource for sidelink communication is selected based on the monitoring result of a signal monitoring operation.

The sidelink communication device may select the transmission resource for sidelink communication, such as a time-frequency resource, in an independent resource selecting mode. The sidelink communication device may perform data transmission by using the selected transmission resource, and may also reserve the selected transmission resource and inform the selected transmission resource to other sidelink communication devices through the signaling, so that when other sidelink communication devices select the own transmission resources, resource collision can be avoided as much as possible.

Optionally, the sidelink communication device selects the transmission resource for sidelink communication from a resource selecting window based on the monitoring result of the signal monitoring operation. The resource selecting window includes transmission resources that can be selected and reserved by the sidelink communication device. The sidelink communication device removes transmission resources unsuitable for selection from the resource selecting window according to the monitoring result, and performs data transmission and/or reservation by selecting suitable transmission resources from transmission resources suitable for selection. Optionally, the resource selecting window is in the first time unit, that is, the sidelink communication device selects the transmission resource in the first time unit. In this way, the sidelink communication device may perform a receiving and sending operation in an active time unit, may enter an energy-saving state in an inactive unit without performing the receiving and sending operation.

Optionally, a signal monitoring window in which the signal monitoring operation is performed is before a resource selecting window, and the number of time units between the signal monitoring window and the resource selecting window is not less than M, where M is a positive integer. For example, the number of time units between the start time domain position of the signal monitoring window and the start time domain position of the resource selecting window is not less than M. The sidelink communication device first obtains the monitoring result by performing the signal monitoring operation in the signal monitoring window, and then selects the transmission resource for sidelink communication from the resource selecting window based on the monitoring result. The above-described M defines the number of the time units corresponding to the monitoring result that can be used during resource selection. For example, when M=6, the sidelink communication device can perform resource selection by using the monitoring results in at least six time units. In addition, the time units here may be logical time units. Optionally, the above-described M is a fixed value, or the M is preconfigured or configured by a base station through a downlink signaling, which will not be limited by the examples of the disclosure.

In addition, in NR V2X, non-periodic resource reservation is supported. Each current transmission may reserve several time-sequence resources (determined by configuration or preconfiguration) with the same size at any position in the future W logical time units. According to the communication protocol, W is a fixed value 32 logical slots. NR V2X also supports periodic resource reservation, and may be enabled and disabled through configuration or preconfiguration. For example, the value of M is 31, because for non-periodic resource reservation, the sidelink communication device may freely select a time-frequency resource used by the current transmission and a time-frequency resource needing to be reserved in at most 32 continuous logical time units. Assuming that the sidelink communication device performs resource selection in the slot n, the sidelink communication device may select time-frequency resources in 32 slots from the slot n to the slot n+31, and may use the monitoring results in 31 slots from the slot n-1 to the slot n-31 during resource selection.

Optionally, the number of the time units included in the resource selecting window is not less than L, and L is a positive integer. Optionally, L is a fixed value, or L is preconfigured or configured by a base station through a downlink signaling. For example, the values of L may be the same or different according to different quantities of the time-frequency resources that the sidelink communication device wants to select during resource selection; for another example, the values of L may be the same or different according to different priorities of to-be-transmitted data during resource selection of the sidelink communication device. In addition, if the number of the time units included in the current resource selecting window is less than L, the sidelink communication device may perform resource selection in the next resource selecting window. In this way, it can be ensured that the resource selecting window has sufficient resources for the device to select, the randomization of resource selection is improved, and the probability of resource collision is reduced.

Optionally, in the case that time when resource selection is triggered is outside the first time unit, the sidelink communication device starts to perform a signal monitoring operation from the time unit before the first time unit. If the time when resource selection is triggered is earlier than the time domain start position of the first time unit, the sidelink communication device may start to perform the signal monitoring operation in advance before the time domain start position of the first time unit without waiting until entering the first time unit to start to perform the signal monitoring operation, which is beneficial to reserve sufficient time units for the resource selecting window and improve the resource selection efficiency.

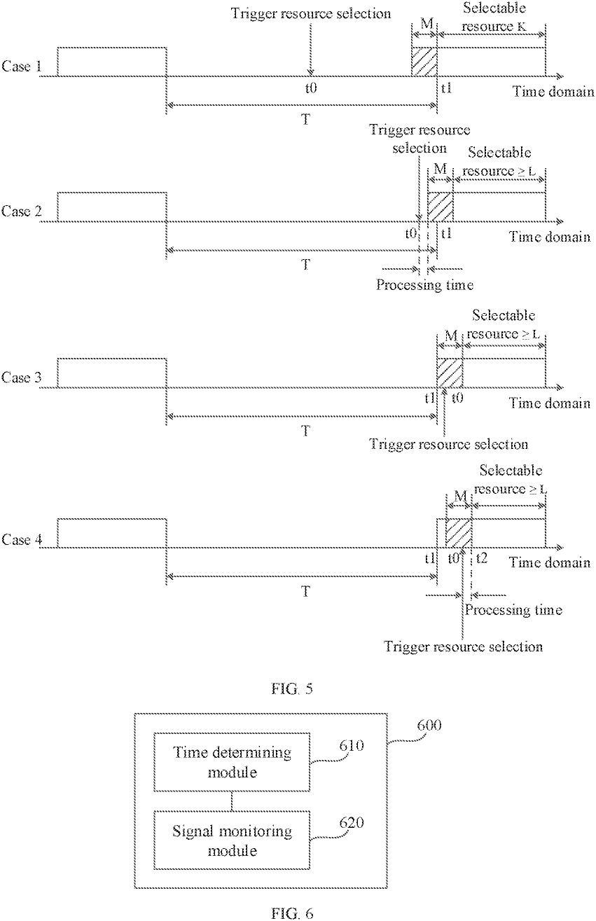

An example that the sidelink communication device performs signal monitoring and resource selection at different resource selection triggering times is described below with reference to FIG. 5.

For Case 1: a time t0 when resource selection is triggered is before the time domain start position t1 of the first time unit, and the number of time units between t0 and t1 is not less than M, the sidelink communication device may start to perform a signal monitoring operation ahead of M time units before t1, and perform resource selection based on the monitoring result in the first time unit. In this case, the monitoring result used for resource selection may be the monitoring result in M time units (M time units shown in slashes filled in the figure) before t1.

For Case 2: a time t0 when resource selection is triggered is before the time domain start position t1 of the first time unit, and the number of time units between t0 and t1 is less than M, the sidelink communication device may start to perform a signal monitoring operation in advance before t1, and continuously perform the signal monitoring operation after entering the first time unit until a monitoring duration reaches M time units, and then perform resource selection based on the monitoring result in the remaining time frequency resource of the first time unit. In this case, the monitoring result used for resource selection may be the monitoring result in M time units (such as M time units shown in slashes filled in the figure) before and after t1.

For case 3: a time t0 when resource selection is triggered is after the time domain start position t1 of the first time unit and is in the previous M time units of the first time unit, the sidelink communication device may perform a signal monitoring operation in the previous M time units of the first time unit, and perform resource selection based on the monitoring result in the remaining time-frequency resource of the first time unit. In this case, the monitoring result used for resource selection may be the monitoring result in the previous M time units (such as M time units shown in slashes filled in the figure) of the first time unit.

For case 4: a time t0 when resource selection is triggered plus the necessary processing time (such as a time t2 corresponding to the dotted line in the figure) is after the previous M time units of the first time unit, the sidelink communication device may perform resource selection based on the monitoring result directly in the remaining time-frequency resource after the time t2. In this case, the monitoring result used for resource selection may be the monitoring result in M time units (M time units shown in slashes filled in the figure) before the time t2.

It should be noted here that a necessary processing time may be undergone after the resource selection is triggered, and resource selection is started after the processing time. In addition, for Cases 2 to 4, it needs to be ensured that the number of selectable active time units exceeds L, otherwise the sidelink communication device may perform resource selection in the next period.

In FIG. 5, the case where the first time unit is a plurality of continuous time units is merely shown, but those skilled in the art understands that the technical solutions described above may also be applied to the case where the first time unit is a plurality of discontinuous time units.

The apparatus examples of the disclosure described below may be used to perform the method examples of the disclosure. For details not disclosed in the apparatus examples of the disclosure, refer to the method examples of the disclosure.

FIG. 6 is a block diagram of a monitor apparatus in sidelink communication according to an example. The apparatus has the function for implementing the above method example. The function may be implemented by hardware or may be implemented by corresponding software executed by hardware. The apparatus may be a sidelink communication device, or may be arranged in a sidelink communication device. As shown in FIG. 6, the apparatus 600 may include: a time determining module 610 and a signal monitoring module 620.

The time determining module 610 is configured to: for a sidelink communication resource pool of a sidelink communication device, determine a first time unit in the sidelink communication resource pool.

The signal monitoring module 620 is configured to perform a signal monitoring operation in the first time unit.

Optionally, the first time unit is periodic.

Optionally, in one period, the first time unit is one time unit or a plurality of continuous time units.

Optionally, the time determining module 610 is configured to determine the first time unit in the sidelink communication resource pool based on configuration information.

Optionally, the configuration information includes at least one of:
a period of the first time unit;
a time domain start position of the first time unit in one period;
a time domain end position of the first time unit in one period;
a time domain length of the first time unit in one period; and
a time domain bitmap of the first time unit in one period.

Optionally, the configuration information includes a plurality of candidate configuration values, where each of the configuration values corresponds to one group of configuration parameters.

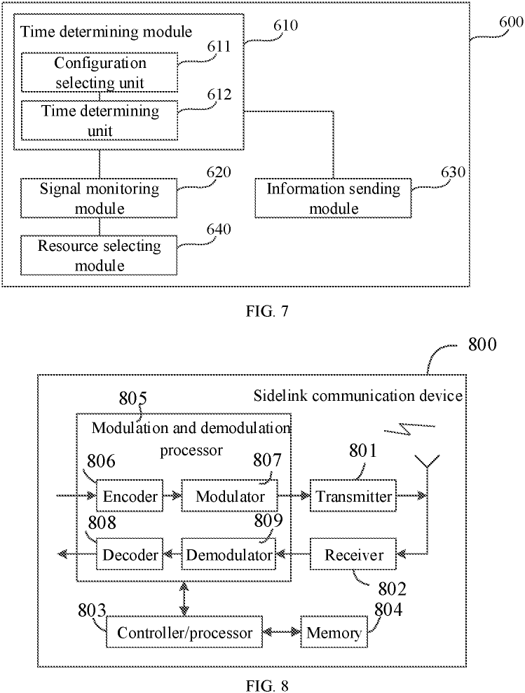

As shown in FIG. 7, the time determining module 610 includes:
a configuration selecting unit 611, configured to select a first configuration value from the plurality of candidate configuration values; and
a time determining unit 612, configured to determine the first time unit in the sidelink communication resource pool based on the configuration parameters corresponding to the first configuration value.

Optionally, the configuration selecting unit 611 is configured to select the first configuration value from the plurality of candidate configuration values according to a resource reservation period of to-be-sent or to-be-received sidelink communication information.

Optionally, the period of the first time unit is the same as or in an integral multiple relationship with the resource reservation period.

Optionally, the configuration selecting unit 611 is configured to select the first configuration value from the plurality of candidate configuration values according to a priority of to-be-sent or to-be-received sidelink communication information.

Optionally, the configuration information further includes a mapping relationship between the configuration values and the priority.

Optionally, the configuration information is preconfigured, or the configuration information is configured by a base station through a downlink signaling.

Optionally, as shown in FIG. 7, the apparatus 600 further includes:

an information sending module 630, configured to send time domain position indicating information to other sidelink communication devices, where the time domain position indicating information is used to indicate a time domain position of the first time unit.

Optionally, the information sending module 630 is configured to: send SCI to the other sidelink communication devices, where the SCI includes the time domain position indicating information; or send a sidelink RRC message to the other sidelink communication devices, where the sidelink RRC message includes the time domain position indicating information.

Optionally, the time domain position indicating information is used by the other sidelink communication devices to determine a time unit at which a signal monitoring operation is performed and/or a time unit at which an energy-saving state enters in the own sidelink communication resource pool.

Optionally, as shown in FIG. 7, the apparatus 600 further includes:

a resource selecting module 640, configured to select a transmission resource for sidelink communication based on the monitoring result of the signal monitoring operation.

Optionally, the resource selecting module 640 is configured to select the transmission resource for sidelink communication from a resource selecting window based on the monitoring result of the signal monitoring operation, where the resource selecting window is in the first time unit.

Optionally, a signal monitoring window in which the signal monitoring operation is performed is before the resource selecting window, and time unit of an interval between the signal monitoring window and the resource selecting window is not less than M, where M is a positive integer.

Optionally, the M is a fixed value, or the M is preconfigured or configured by a base station through a downlink signaling.

Optionally, the number of time units included in the resource selecting window is not less than L, and the L is a positive integer.

Optionally, the L is a fixed value, or the L is preconfigured or configured by a base station through a downlink signaling.

Optionally, the signal monitoring module 620 is configured to perform the signal monitoring operation from a time unit before the first time unit in the case that time when resource selection is triggered is outside the first time unit.

Optionally, the signal monitoring operation includes a monitoring operation for a signal and/or a channel for sidelink communication.

In conclusion, according to the technical solutions provided by the examples of the disclosure, for the sidelink communication resource pool of the sidelink communication device, the first time unit in the sidelink communication resource pool is determined, the signal monitoring operation is performed in the first time unit, so that the sidelink communication device may perform the signal monitoring operation in one part of the time unit in the sidelink communication resource pool, and may enter the energy-saving state in the other part of the time unit without performing the signal monitoring operation, so that the time for performing the signal monitoring operation is shortened and the electric quantity of the device is saved.

It should be noted that when the apparatus provided by the above example implements the function, division of the above function modules is merely used as an example for description. In practical applications, based on the actual requirement, the above functions may be allocated to and completed by different function modules. That is, the content structure of the device is divided into different function modules, so as to complete all or some of the functions described above.

For the apparatus in the above example, a specific manner of each module in the apparatus performing an operation is already described in the method-related example in detail, and is no longer described here in detail.

An example of the disclosure further provides a monitoring apparatus in sidelink communication, which can implement the monitoring method in sidelink communication provided by the examples of the disclosure. The apparatus may be a sidelink communication device, or may be arranged in a sidelink communication device. The apparatus may include: a processor, and a memory used to store executable instructions of the processor. The processor is configured to execute the executable instruction to implement the above monitoring method in sidelink communication.

FIG. 8 is a structural schematic diagram of a sidelink communication device according to an example.

The sidelink communication device 800 includes a transmitter 801, a receiver 802 and a processor 803. The processor 803 may further be a controller, which is shown as “controller/processor 803” in FIG. 8. Optionally, the sidelink communication device 800 may further include a modulation and demodulation processor 805, where the modulation and demodulation processor 805 may include an encoder 806, a modulator 807, a decoder 808 and a demodulator 809.

In one example, the transmitter 801 adjusts (for example, analog transformation, filtering, amplification, up-conversion and the like) the output sampling and generates an uplink signal, and the uplink signal is transmitted by an antenna to the access network device in the above examples. On the downlink, the antenna receives a downlink signal transmitted by the access network device in the above example. The receiver 802 adjusts (for example, filtering, amplification, down-conversion, digitization and the like) the signal received from the antenna and provides input sampling. In the modulation and demodulation processor 805, the encoder 806 receives service data and a signaling message to be sent on the uplink, and processes (for example, formatting, encoding and interweaving) the service data and the signaling message. The modulator 807 further processes (for example, symbol mapping and modulation) the encoded service data and signaling message, and provides output sampling. The demodulator 809 processes (for example, demodulation) the input sampling and provides symbol estimation. The decoder 808 processes (for example, de-interweaving and decoding) the symbol estimation, and provides the decoded data and signaling message sent to the sidelink communication device 800. The encoder 806, the modulator 807, the demodulator 809 and the decoder 808 may be implemented by the synthesized modulation and demodulation processor 805. These units are processed by a wireless access technology used by a wireless access network. It should be noted that when the sidelink communication device 800 does not include the modulation and demodulation processor 805, the above functions of the modulation and demodulation processor 805 may also be completed by the processor 803.

The processor 803 performs control management on the action of the sidelink communication device 800, and is used to perform the processing process performed by the sidelink communication device 800 in the examples of the disclosure. For example, the processor 803 is further used to perform various steps of the method examples, and/or other steps of the technical solutions described by the examples of the disclosure.

Further, the sidelink communication device 800 may further include a memory 804, where the memory 804 is used to store a program code and data for the sidelink communication device 800.

It may be understood that FIG. 8 merely shows simplified design of the sidelink communication device 800. In actual application, the sidelink communication device 800 may include any quantity of transmitters, receivers, processors, modulation and demodulation processors, memories and the like. All the sidelink communication devices that may implement the examples of the disclosure are all in the protection scope of the examples of the disclosure.

The examples of the disclosure further provide a non-transitory computer-readable storage medium, where the non-transitory computer-readable storage medium stores a computer program, and when the computer program is executed by the processor of the sidelink communication device, the monitoring method in sidelink communication described above is implemented.

Optionally the computer-readable storage medium may include: a read-only memory (ROM), a random access memory (RAM), solid state drives (SSD), an optical disc, or the like. The random access memory may include a resistance random access memory (ReRAM) and a dynamic random access memory (DRAM).

The examples of the disclosure further provide a computer program product. When the computer program product runs on the processor of the sidelink communication device, the sidelink communication device performs the monitoring method in sidelink communication.

It should be understood that “a plurality of” mentioned here refers to two or more than two. “And/or”, which describes a relationship of associated objects, indicates that three relationships may be presented, for example, A and/or B may indicate three cases: A is present alone, A and B are present at the same time, or B is present alone. The character “/” here generally indicates that the associated objects are in an “or” relationship.

Other examples of the disclosure will be apparent to those skilled in the art from consideration of the specification and practice of the disclosure. The disclosure is intended to cover any variations, uses, or adaptations of the disclosure following the general principles of the disclosure and including common knowledge or commonly used technical measures which are not disclosed here. The description and the examples are merely regarded as exemplary, and the real scope and spirit of the disclosure are pointed out by the following claims.

It should be understood that the disclosure is not limited to the exact structure that has been described above and illustrated in the accompanying drawings, and that various modifications and changes may be made without departing from the scope of the disclosure. The scope of the disclosure is only limited by the appended claims.

1. A monitoring method in sidelink communication, perfomed by a sidelink communication device, the monitoring method comprising:
for a sidelink communication resource pool of the sidelink communication device, determining a first time unit in the sidelink communication resource pool; and
performing a signal monitoring operation in the first time unit.

2. The monitoring method according to claim 1, wherein the first time unit is periodic;
wherein in one period, the first time unit is one time unit or a plurality of continuous time units.

3. (canceled)

4. The monitoring method according to claim 1, wherein determining the first time unit in the sidelink communication resource pool comprises:
determining the first time unit in the sidelink communication resource pool based on configuration information.

5. The monitoring method according to claim 4, wherein the configuration information comprises at least one of:
a period of the first time unit;
a time domain start position of the first time unit in one period;
a time domain end position of the first time unit in one period;
a time domain length of the first time unit in one period; and
a time domain bitmap of the first time unit in one period.

6. The monitoring method according to claim 4, wherein the configuration information comprises a plurality of candidate configuration values, each of the plurality of candidate configuration values corresponding to one group of configuration parameters; and
determining the first time unit in the sidelink communication resource pool based on the configuration information comprises:
selecting a first configuration value from the plurality of candidate configuration values, and
determining the first time unit in the sidelink communication resource pool based on the configuration parameters corresponding to the first configuration value.

7. The monitoring method according to claim 6, wherein selecting the first configuration value from the plurality of candidate configuration values comprises:
selecting the first configuration value from the plurality of candidate configuration values according to a resource reservation period of to-be-sent or to-be-received sidelink communication information.

8. The monitoring method according to claim 7, wherein a period of the first time unit is the same as or in an integral multiple relationship with the resource reservation period.

9. The monitoring method according to claim 6, wherein selecting the first configuration value from the plurality of candidate configuration values comprises:
selecting the first configuration value from the plurality of candidate configuration values according to a priority of to-be-sent or to-be-received sidelink communication information.

10. The monitoring method according to claim 9, wherein the configuration information further comprises a mapping relationship between the plurality of candidate configuration values and the priority.

11. The monitoring method according to claim 4, wherein the configuration information is preconfigured, or the configuration information is configured by a base station through a downlink signaling.

12. The monitoring method according to claim 1, further comprising:
sending time domain position indicating information to other sidelink communication devices, wherein the time domain position indicating information is used to indicate a time domain position of the first time unit.

13. The monitoring method according to claim 12, wherein sending the time domain position indicating information to other sidelink communication devices comprises:
sending sidelink control information (SCI) to other sidelink communication devices, the SCI comprising the time domain position indicating information; or,
sending a sidelink radio resource control (RRC) message to the other sidelink communication devices, the sidelink RRC message comprising the time domain position indicating information.

14. The monitoring method according to claim 12, wherein the time domain position indicating information is used by the other sidelink communication devices to determine at least one of a time unit at which a signal monitoring operation is performed and a time unit at which an energy-saving state enters in the own sidelink communication resource pool.

15. The monitoring method according to claim 1, further comprising:
selecting a transmission resource for sidelink communication based on a monitoring result of the signal monitoring operation.

16. The monitoring method according to claim 15, wherein selecting the transmission resource for sidelink communication based on the monitoring result of the signal monitoring operation comprises:
selecting the transmission resource for sidelink communication from a resource selecting window based on the monitoring result of the signal monitoring operation, wherein
the resource selecting window is in the first time unit.

17. The monitoring method according to claim 16, wherein a signal monitoring window in which the signal monitoring operation is performed is before the resource selecting window, and a number of time units of an interval between the signal monitoring window and the resource selecting window is not less than M, M is a positive integer;
wherein the M is a fixed value, or the M is preconfigured or configured by a base station through a downlink signaling.

18. (canceled)

19. The monitoring method according to claim 16, wherein a number of time units comprised in the resource selecting window is not less than L, and the L is a positive integer;
wherein the L is a fixed value, or the L is preconfigured or configured by a base station through a downlink signaling.

20. (canceled)

21. The monitoring method according to claim 15, further comprising:
performing the signal monitoring operation from a time unit before the first time unit in case that time when resource selection is triggered is outside the first time unit.

22. The monitoring method according to claim 1, wherein the signal monitoring operation comprises a monitoring operation for at least one of a signal and a channel for sidelink communication.

23. (canceled)

24. A monitoring apparatus in sidelink communication, comprising:
a processor; and
a memory configured to store an executable instruction of the processor,
wherein the processor is configured to execute the executable instruction to:
for a sidelink communication resource pool of a sidelink communication device, determine a first time unit in the sidelink communication resource pool; and
perform a signal monitoring operation in the first time unit.

25. (canceled)
